(19) United States
(12) Patent Application Publication
(10) Pub. No.: US 2009/0295836 A1
(43) Pub. Date: Dec. 3, 2009

(54) System and method for representing large activity diagrams

(75) Inventor: Thomas A. King, Danville, CA (US)

Correspondence Address: REED SMITH LLP, 101 Second Street, Suite 1800, SAN FRANCISCO, CA, 94105, US

(73) Assignee: Ravenflow, Inc.

(21) Appl. No.: 12/154,699

(22) Filed: May 27, 2008

(51) Int. Cl. G09G 5/00

(52) U.S. Cl. 345/666; 345/619

(57) ABSTRACT

An Activity Diagram is partitioned into appropriately-sized panels. The panels are arranged in the time order of the activities in them. Unused swim lanes are eliminated from each panel, and thus each panel is compressed without adversely affecting legibility. Each swim lane is labeled on each panel. Conditional elements are repeated (and flagged when repeated) if necessary to represent their second path on one or more later panels in the sequence. The panels are displayed to a reader in any of a number of possible media (e.g., electronic, printed, etc.). The system and method solve the large diagram problem by simultaneously allowing for readability and navigability.

### BACKGROUND OF THE INVENTION

1. Field of the Invention

The present invention relates generally to the representation of Activity Diagrams, for example, diagrams such as those defined in the Unified Modeling Language (“UML”) specification, and also those taking other forms. More particularly, the present invention relates to a system and method for representing large Activity Diagrams in a manner that is both legible and navigable.

2. Description of the Related Art

In the Unified Modeling Language (“UML”) specification, an Activity Diagram represents the business and operational step-by-step workflows of components in a system. An Activity Diagram shows the overall flow of control. These diagrams are very useful in portraying the flow of business processes or the flow of a use case in defining software requirements. However, a serious problem exists in displaying large Activity Diagrams to users, reviewers and readers. When the diagram becomes larger than can be easily viewed on a computer screen or in a printed document of standard page size, it either becomes illegible due to compression or it becomes difficult to navigate and to follow the flow of the process.

Example

The following is an example of a small use case describing a business process:
XYZ Sales sells a Product to the Customer and enters the Order in the Sales Order System. The Sales Order System validates the Order. If the Sales Order System determines that the Order is valid, then the Sales Order System enters the Order into the XYZ Delphic system and sends a notice to the XYZ Shipping System. The XYZ Shipping System sends a “Ship-the-Product” email to the XYZ Shipping Group. Otherwise, the Sales Order System displays an invalid order message to XYZ Sales.

The Activity Diagram that represents this textual use case is shown in FIG. 1. As a side note, the diagram was produced automatically from the plain English text of the use case by a product called “RAVEN”™ from Ravenflow, Inc. (see U.S. Pat. No. 7,085,708). The Activity Diagram is legible and easy to navigate on the single page it occupies. Each column (called a “swim lane”) contains the actions performed by the actor named at the top of the swim lane. The time sequence of actions proceeds vertically down the diagram. Note that this is a simpler representation than a formal UML representation of an Activity Diagram, but it contains the essential elements required in order to visually reflect the process flow. Actions are represented in rectangles, objects are represented in ovals, decision points are represented in diamonds, and the arrows represent the flow. These graphical elements in an Activity Diagram are often referred to as “glyphs.” A transfer of control from one actor to another is shown as a horizontal arrow, often accompanied by an object (oval) that is transferred from one actor to another. By convention, system actors are placed in the right-most swim lanes.

A problem arises, however, with a more extensive use case resulting in a larger Activity Diagram. This “large diagram problem” has plagued modelers for many years. Some have resorted to printing the diagrams on plotters that can accommodate “E-size” paper. Others have printed out sections and encouraged the reader to tape them together in the right horizontal and vertical sequence. Representing the diagram electronically, the modeler can allow the user to zoom and pan, thereby resolving the legibility problem but limiting the navigability to an electronic screen. Even within a normal computer environment, for example embedding the diagram in a Microsoft Word™ document, the problem of navigating a large diagram that is magnified by a factor of five is daunting. It is easy for a user to get lost using the horizontal and vertical scroll bars and trying to follow the flow.

The problem becomes more acute when the Microsoft Word™ document is printed. The printed document precludes the use of a zoom feature, and the normal “solution” of creating a matrix of diagram pieces (e.g., 1-1, 1-2, 1-3, 2-1, 2-2, 2-3, 3-1, 3-2, 3-3, 4-1, etc.) produces serious navigability problems.

Here is an example of a larger use case with a correspondingly larger Activity Diagram:
XYZ Sales sells a Product to the Customer and enters the Order in the Sales Order System. The Sales Order System validates the Order. If the Sales Order System determines that the Order is valid, then the Sales Order System enters the Order into the XYZ Delphic system and sends a notice to the XYZ Shipping System. The XYZ Shipping System sends a “Ship-the-Product” email to the XYZ Shipping Group. Otherwise, the Sales Order System displays an invalid order message to XYZ Sales. The XYZ Shipping Group adds an Upgrade Kit, consisting of a small cardboard box with a unique RMA # on the box, to the Product, ships the Product and the Upgrade Kit package to the Customer, and enters the RMA # and the Shipping information into the XYZ Shipping System. The XYZ Shipping System then transmits the information to the XYZ Delphic system. The XYZ Delphic system receives a query from the XYZ Aware, locates the Order, and sends an update to the MOON system.
The MOON system then calculates and enters the return due date for the Residual Material. The MOON system writes the order data and due date to the XYZ Returns system twice daily. The XYZ Returns system sends a notice to the XYZ Shipping Group. The XYZ Shipping Group sends the Product and Upgrade Kit package to the Customer. The Customer performs the upgrade, and then sends a request for a scheduled pick-up of the Residual Material to the XYZ Returns system. The XYZ Returns system then sends an update to the MOON system, and sends an email with pickup information to the XYZ Logistics Vendor. The XYZ Logistics Vendor picks up the Residual Material from Customer, delivers the Residual Material to the Warehouse Vendor, and sends a POD by email to the TIS Group.
The TIS Group enters the email data from the XYZ Logistics Vendor into a Staged Data File, and sends a flag to the MOON system. The MOON system retrieves the Staged Data File from the TIS Group and sends the updated data to the MOON system. The MOON system sends a notification to the XYZ Logistics Vendor. The XYZ Logistics Vendor sends the Residual Material to the Warehouse Vendor.
The Warehouse Vendor then sends an email with XYZ part # and RMA # to the TIS Group. The TIS Group enters the email data from the Warehouse Vendor to a Staged Data File. The TIS Group sends an email to the MOON system. The MOON system retrieves the Staged Data File from the TIS Group twice daily and performs a data update procedure.
Every day, the MOON system sends UAP Sales Reports, UAP Finance Reports, and RMA Aging Reports to the DEMI URG. If the DEMI URG determines from the RMA Aging Reports that the Customer has not scheduled a pickup within 60 days of receipt of the Product, the DEMI URG sends the Customer a reminder that the return will be overdue in 30 days. Otherwise, the DEMI URG sends a notice to the XYZ Finance. If the DEMI URG determines from the RMA Aging Reports that the Customer has not scheduled a pickup within 90 days of receipt of the Product, the DEMI URG sends the Customer a notice that the Residual Material is overdue and that the Customer has forfeited the upgrade discount. Otherwise, the DEMI URG processes other transactions.

The full Activity Diagram sized down to fit on one page of a document is shown in FIG. 2. Note that it is easily navigable, but illegible.

As discussed previously, a common solution is to break the diagram up into panels that span both horizontally and vertically. FIGS. 3(A)-3(AB) illustrate such a representation (the diagrams span 28 pages, and are thus very difficult to navigate). The panels of FIGS. 3(A)-3(AB) are legible, but navigating the flow is quite difficult due to the combination of both horizontal and vertical navigation required.

Other examples of prior art include:

1. “Introduction to UML” by Scott Ambler (http://www.agilemodeling.com/artifacts/activityDiagram.htm). Ambler describes the diagram reproduced in FIG. 4:
It shows how activity diagrams can get large very quickly. “Even though it models the logic of a single use case I was forced to have it wind around the whiteboard because I ran out of space. Ideally the diagram should be wider, with the logic going from left-to-right across the board. Better yet, it would be nice to have more whiteboard space.” (quoted from Scott Ambler)

2. Tablet UML (http://www.tabletuml.com/Help/WhatsNew.htm)
Arranging Swim lanes: The context menu for a swim lane in an Activity Diagram has a new option, Arrange . . . When you choose this option, Tablet UML will present you with a list of swim lanes in the current diagram. You can rearrange these swim lanes, and you can also add and delete swim lanes. When you're done, Tablet UML will rearrange the swim lanes in the Activity Diagram and the contents of each swim lane as well.

3. DevShed (http://www.devshed.com/c/a/Practices/FiveStep-UML-OOAD-for-Short-Attention-Spans-Design-Repeat/1/
Rearrange to Make a Legible Diagram
Consider ways to make the Component Diagram more legible:
   Try to avoid crossing lines whenever possible.
   Consider whether you may need to break the Component Diagram into multiple diagrams to show various interactions.
   Hide extraneous details in the diagrams.
Consider also that some rearrangements are worse than others. Save your work, and be ready to undo and try other approaches. Aesthetics and readability can involve a lot of trial and error.
Repeat and rearrange until you're comfortable that you have architecture that can fulfill the scenarios as depicted in the Activity Diagrams.

4. Oracle JDeveloper™
This is an example of a modeling product that provides the ability to hide swim lanes. The problem is that just hiding swim lanes is not enough. It provides a way to focus attention on just the selected actors, but it leaves out parts of the actual flow.

### SUMMARY OF THE INVENTION

In general, the present invention is a system and method for representing large Activity Diagrams in a set of individual panels in which the unused swim lanes are eliminated in each panel and in which the navigation is purely vertical. At a minimum, the present invention helps clarify process flow and provides a legible and navigable visual reference for understanding textual descriptions of systems, software, and other processes.

One implementation of the present invention is based on using the underlying object model produced by RAVEN™ from plain English text. Because that object model is an algebraic representation of the text, the present invention is able to easily leverage that to produce a set of panels that are appropriately partitioned and labeled. However, the invention is not dependent on an underlying object model and can be utilized even in hand-drawn diagrams or in diagrams produced using drag-and-drop tools such as Microsoft Visio™.

In one implementation, the system automatically adjusts the scope of each panel to maintain legibility, to restrict the number of swim lanes to prevent any horizontal spillover, and to accommodate conditional paths that extend beyond the next panel. In the case of conditional paths, the conditional diamond is repeated but with a dashed line outline to indicate a continuation.

According to one embodiment, the present invention is a method for partitioning an Activity Diagram comprising processing an Activity Diagram into a plurality of panels, each panel having at least one vertical swim lane, rendering only those swim lanes that contain glyphs for each respective panel, sizing each panel to fit within preset space limits both horizontally and vertically, while maintaining a legible font and glyph size, labeling each swim lane with an appropriate actor name, sequencing the panels in a correct time sequence of the Activity Diagram, and displaying the panels.

If two paths out of a conditional element cannot be represented within a single panel, then the conditional element is repeated in a subsequent panel to show an additional path, and the repeated conditional element is flagged to show that the conditional element has been repeated.

The process of “displaying” may include printing the partitioned Activity Diagram, rendering the Activity Diagram in an application format, inserting the panels into an electronic document (i.e. by exporting them), and/or inserting the panels into a Microsoft Visio™ document.

The steps of processing, rendering, sizing, labeling, sequencing, and displaying may be automatically performed without user intervention.

The method of the present invention may be embodied in a set of computer instructions stored on a computer readable media, such that when loaded into a computer, the instructions cause the computer to perform the steps of the method.

The present invention also includes a system comprising a diagram rendering module that converts an Activity Diagram or an Activity Diagram's underlying object model into a readable and navigable set of panels, wherein each panel has at least one vertical swim lane; the rendering module rendering only those swim lanes that contain glyphs for each respective panel. The system may further comprise a sizing module to size each panel to fit within preset space limits both horizontally and vertically, while maintaining a legible font and glyph size. The system may additionally comprise a labeling module to label each swim lane with an appropriate actor name, a sequencing module to sequence the panels in a correct time sequence of the Activity Diagram, and/or a display module to display the set of panels electronically. The system may include an export module to export the set of panels electronically to other software programs, and/or a special a print module to print the set of panels on particular printers or plotters.

Portions of both the system and method may be conveniently implemented in programming on a general purpose computer, or networked computers, and the results may be displayed on an output device connected to any of the general purpose, networked computers, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic. cable(s), and co-ax cable(s), etc.

### BRIEF DESCRIPTION OF THE DRAWINGS

The present invention will be readily understood by the following detailed description in conjunction with the accompanying drawings, wherein like reference numerals designate like structural elements, and in which:

FIG. 1 illustrates an example of a small Activity Diagram, according to the prior art;

FIG. 2 is an example of a prior art large Activity Diagram on one page, illustrating the legibility problem;

FIGS. 3(A)-3(AB) illustrate a large Activity Diagram printed on 28 separate pages according to the prior art (illustrating the navigability problem);

FIG. 4 is an example of a prior art diagram;

FIGS. 5(A)-5(F) illustrate an example of a large Activity Diagram on six vertical pages, according to an embodiment of the present invention; and

FIG. 6 is a flowchart of one implementation of a method according to the present invention.

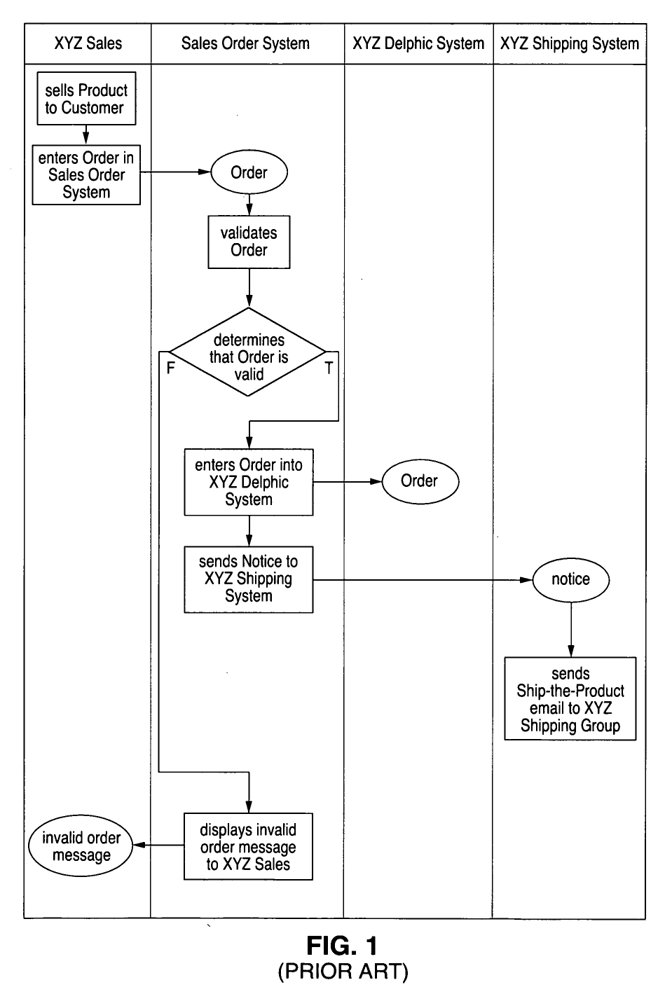

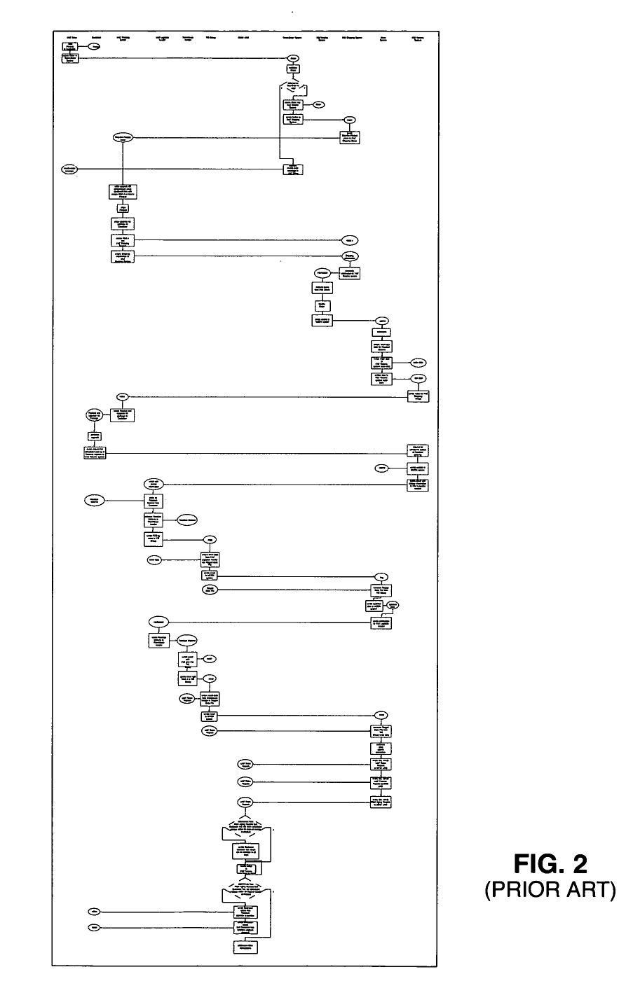

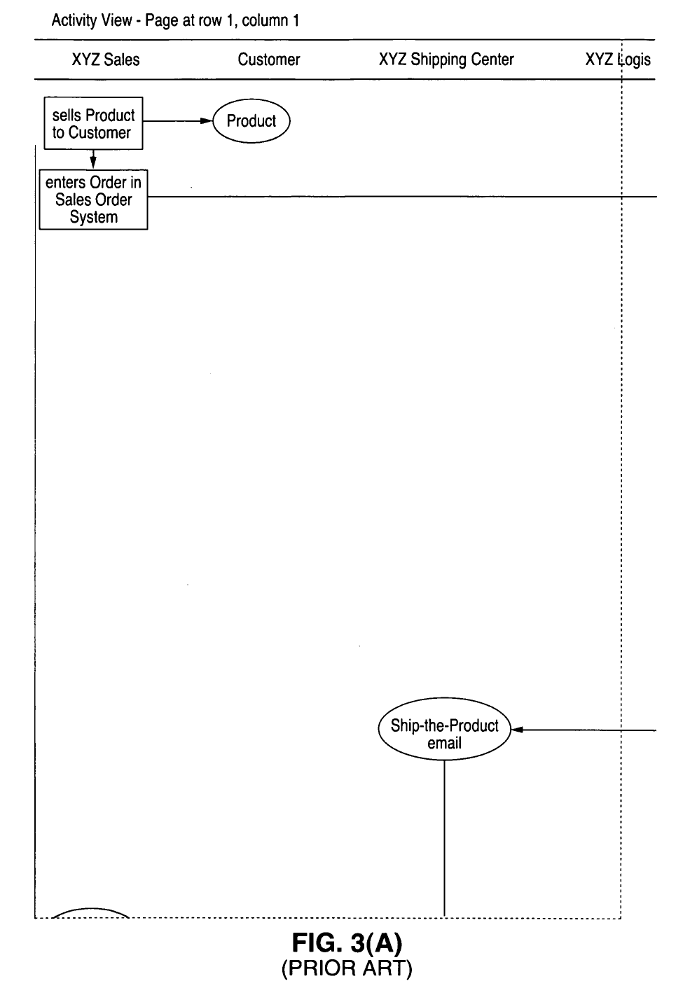

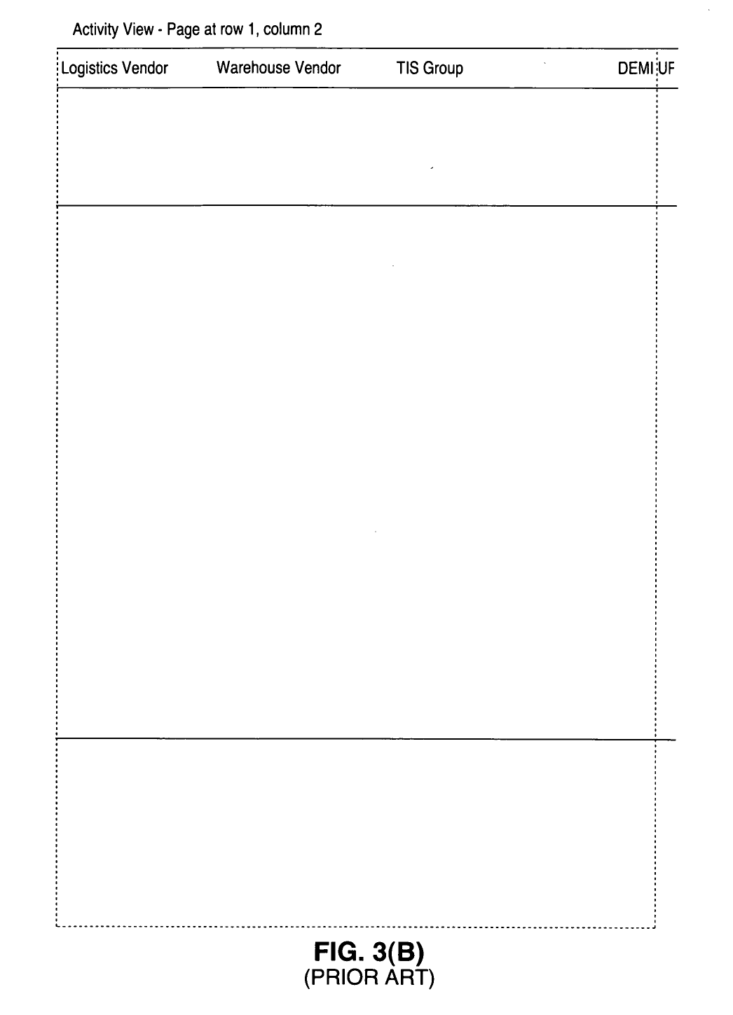

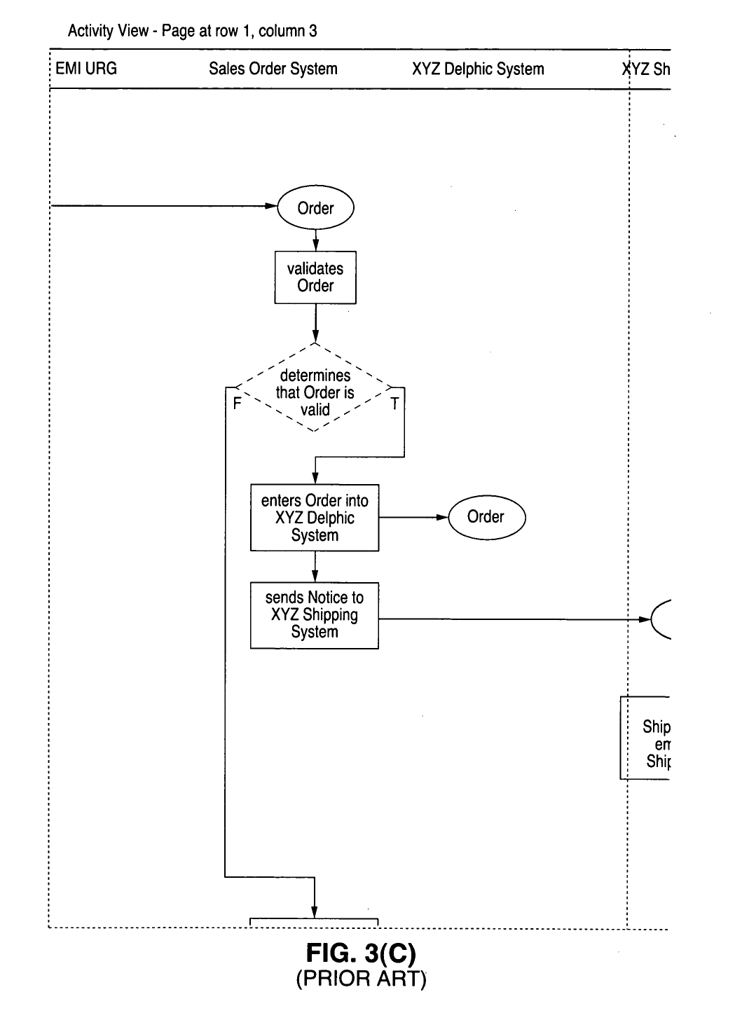

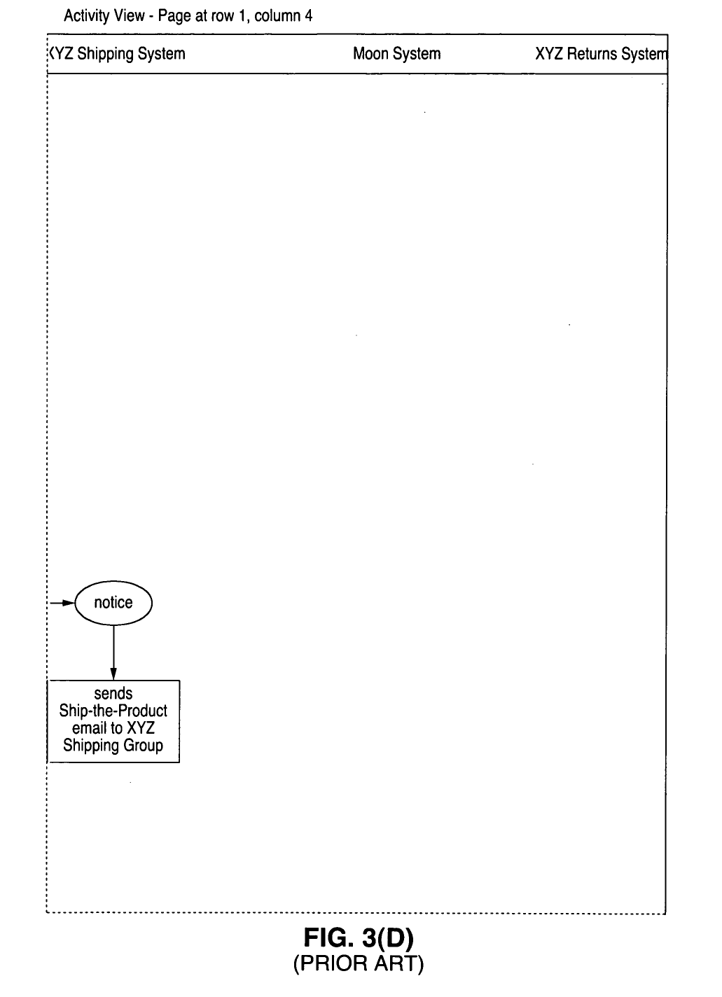

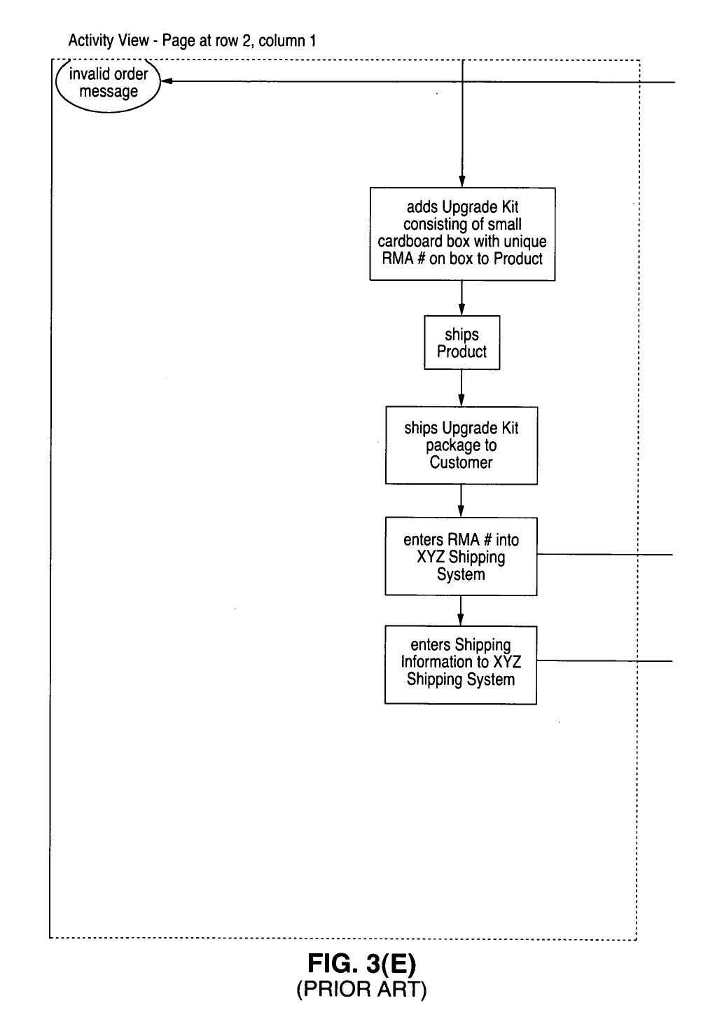

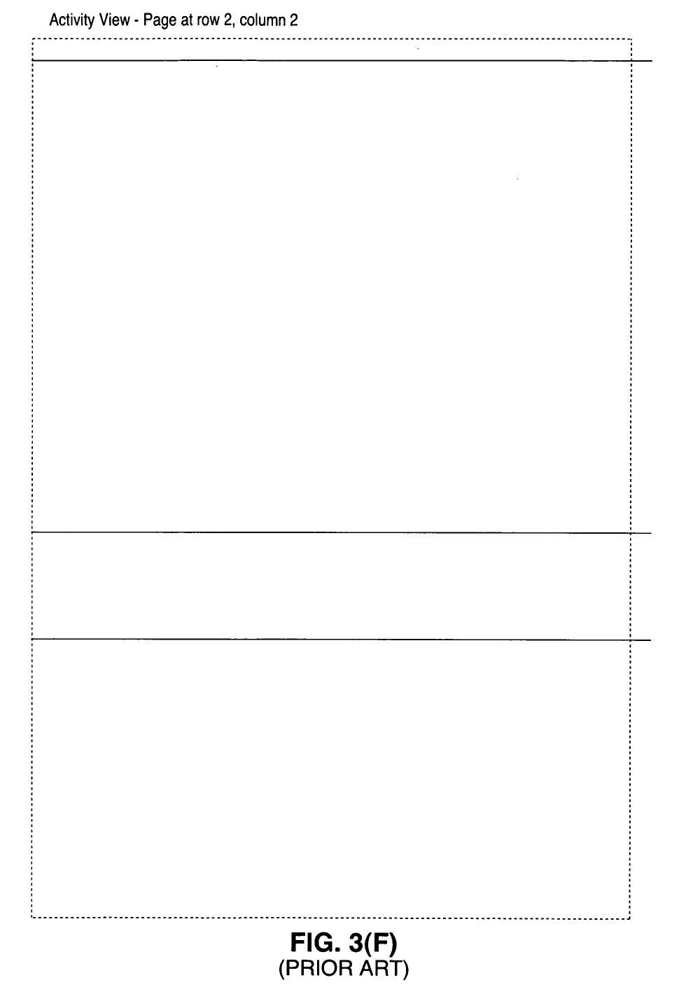

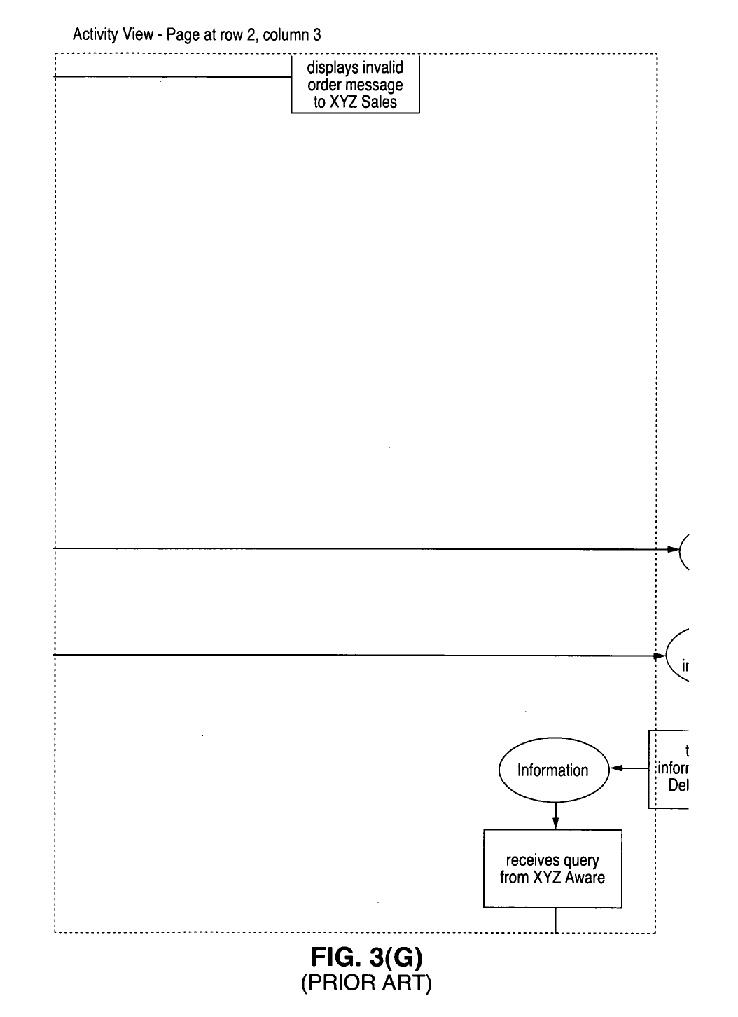

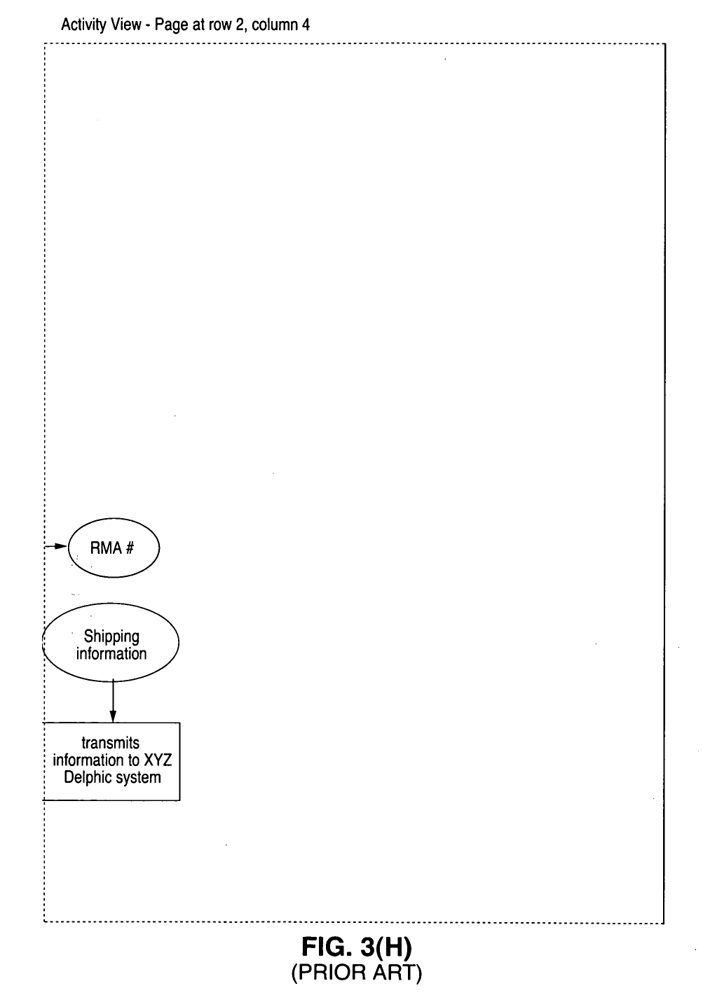

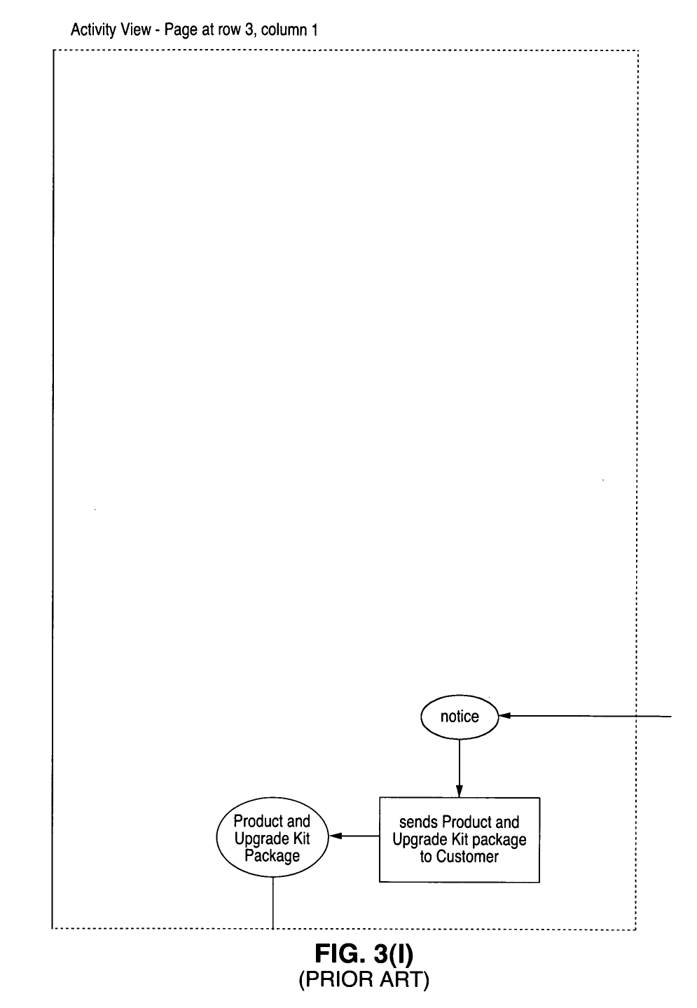

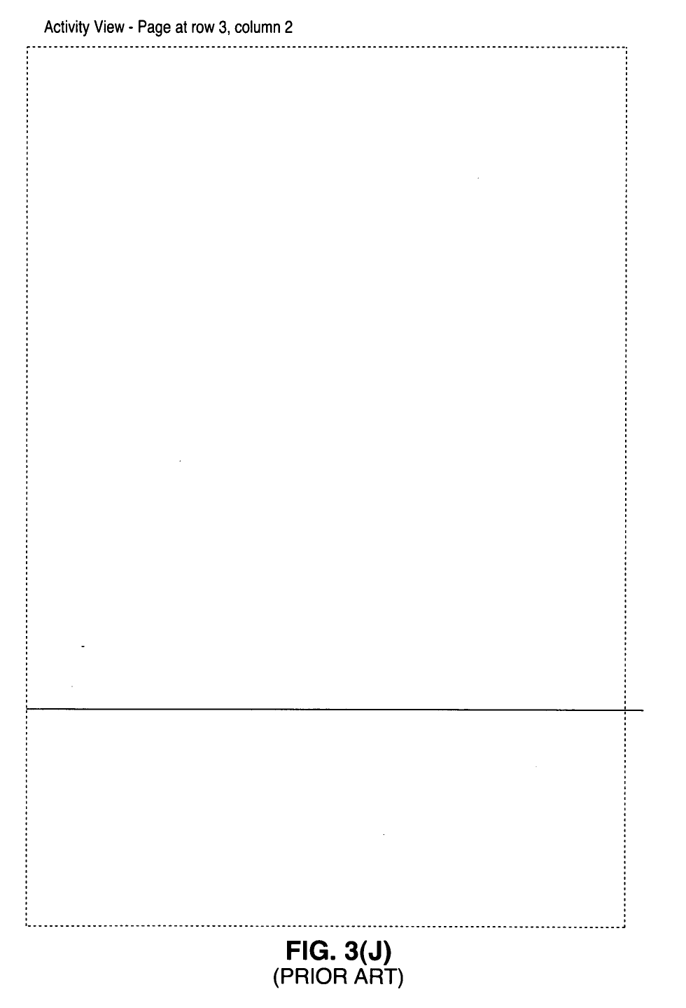

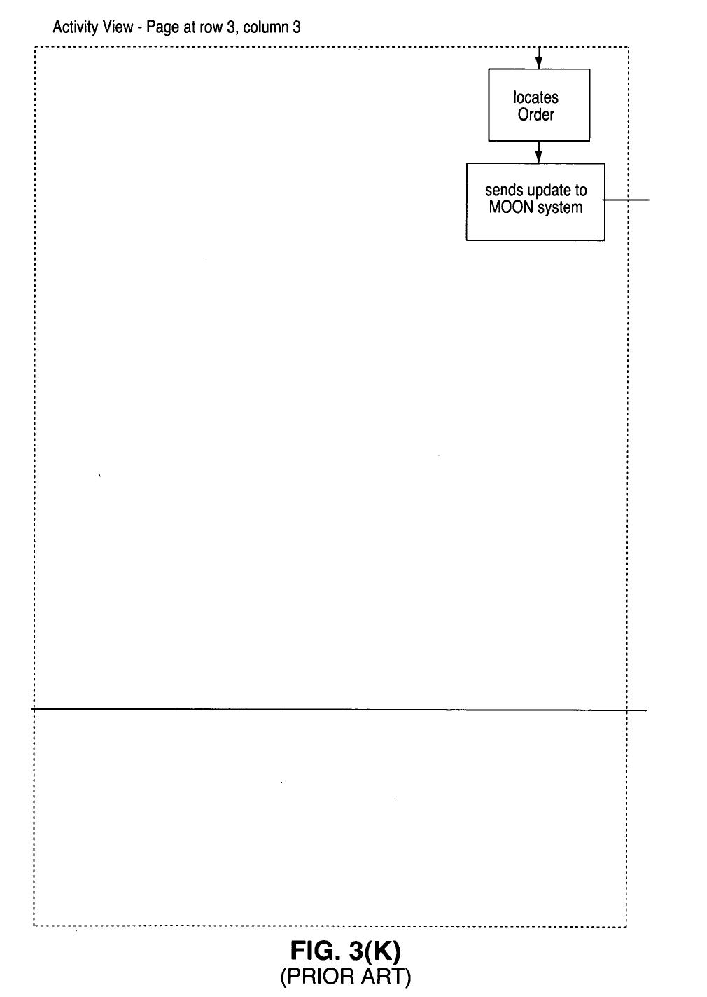

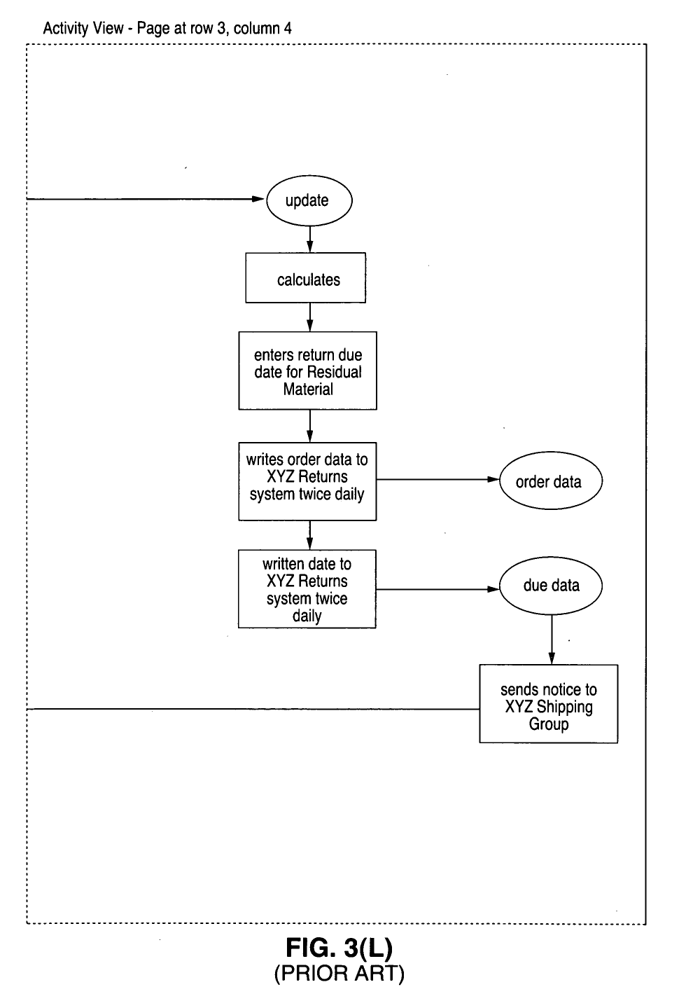

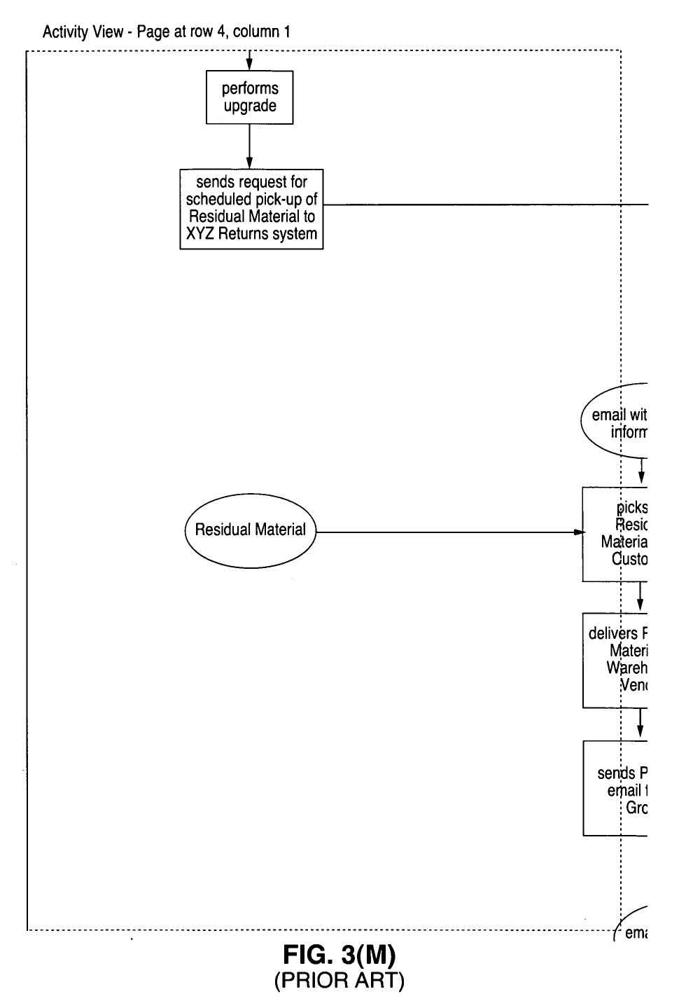

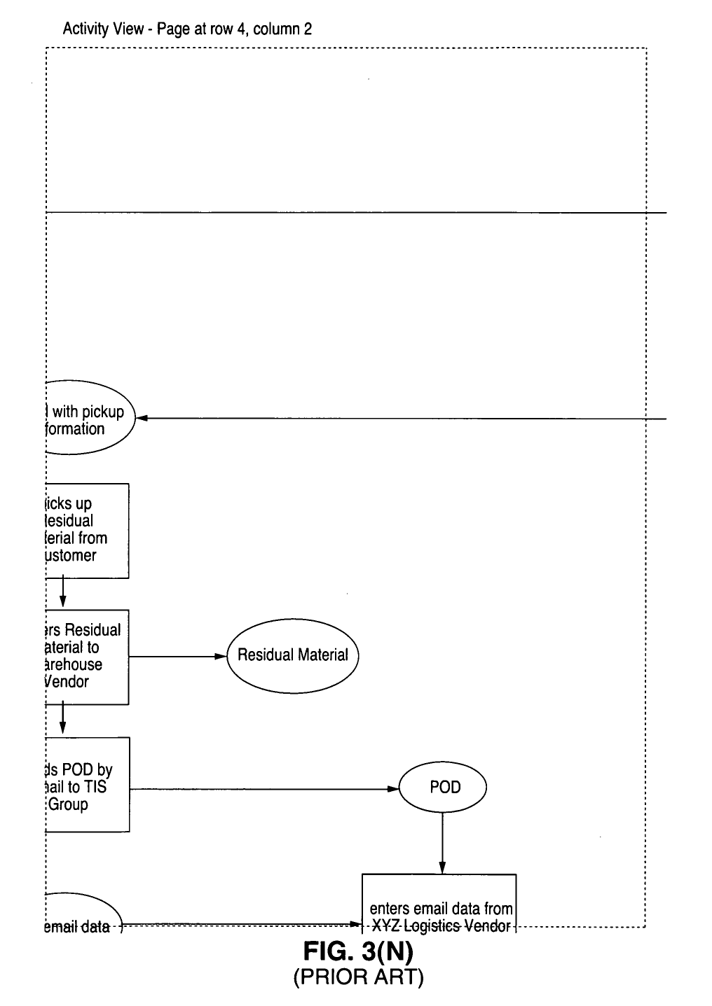

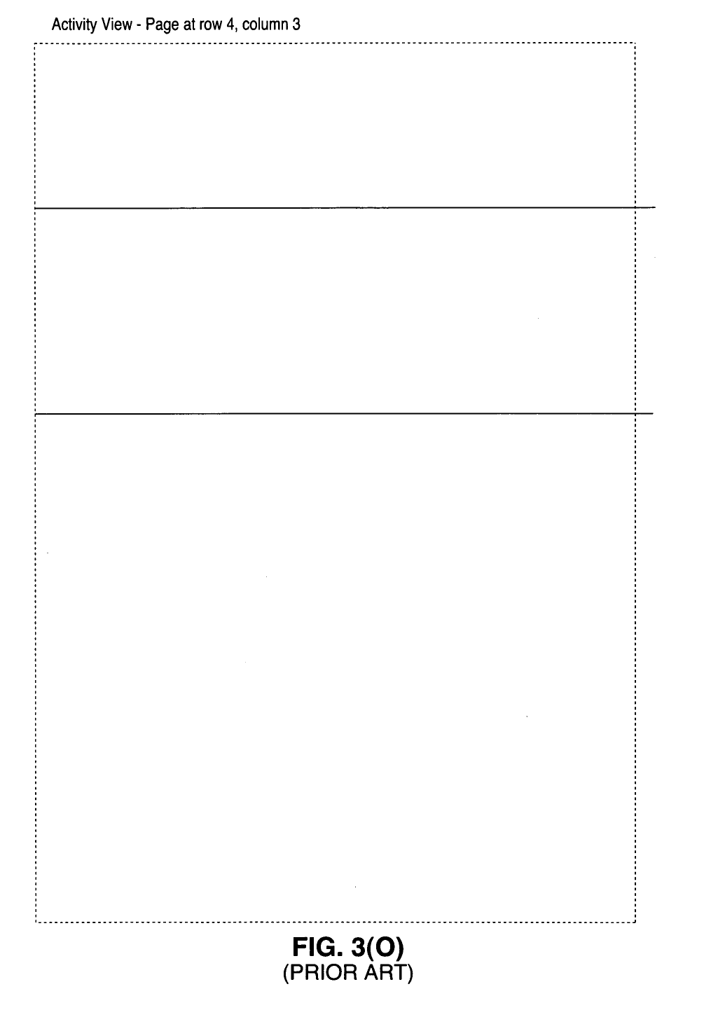

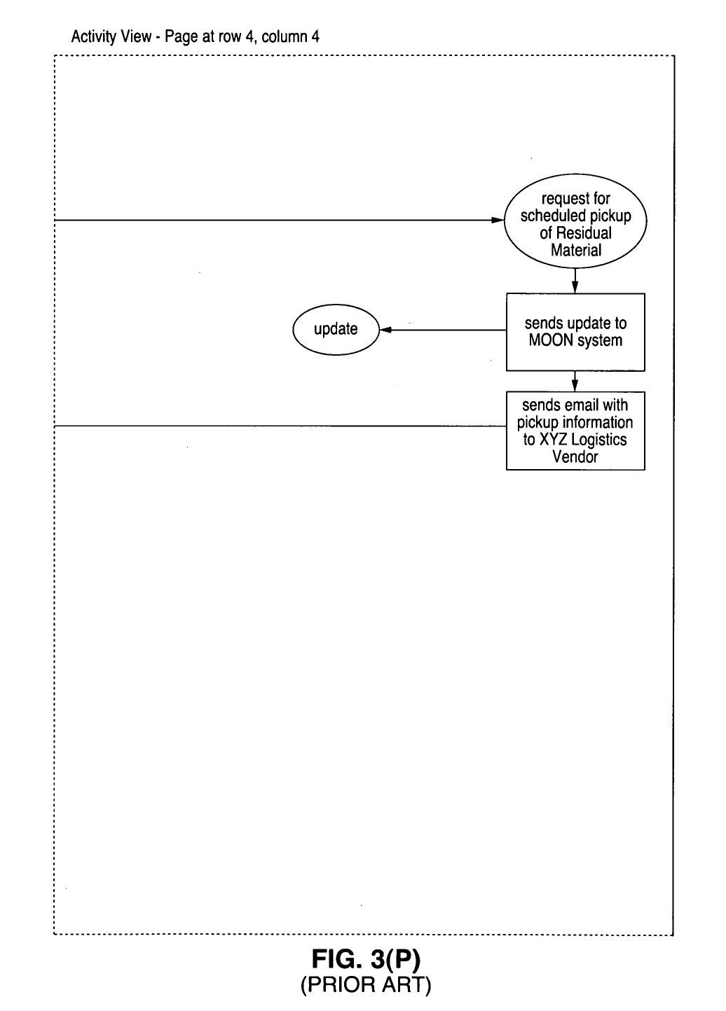

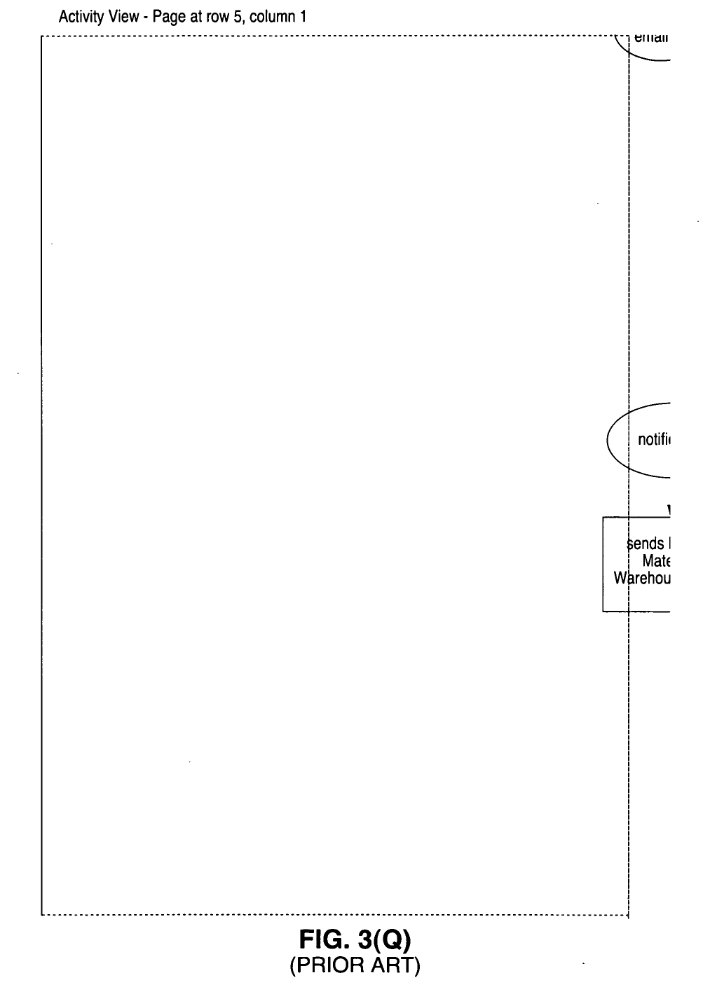

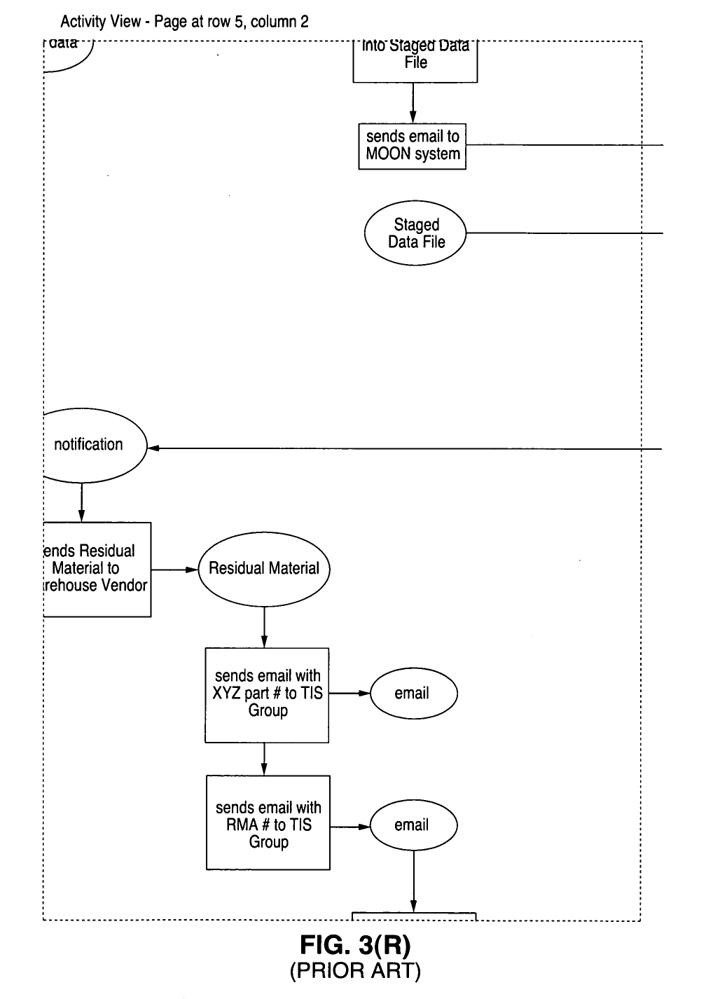

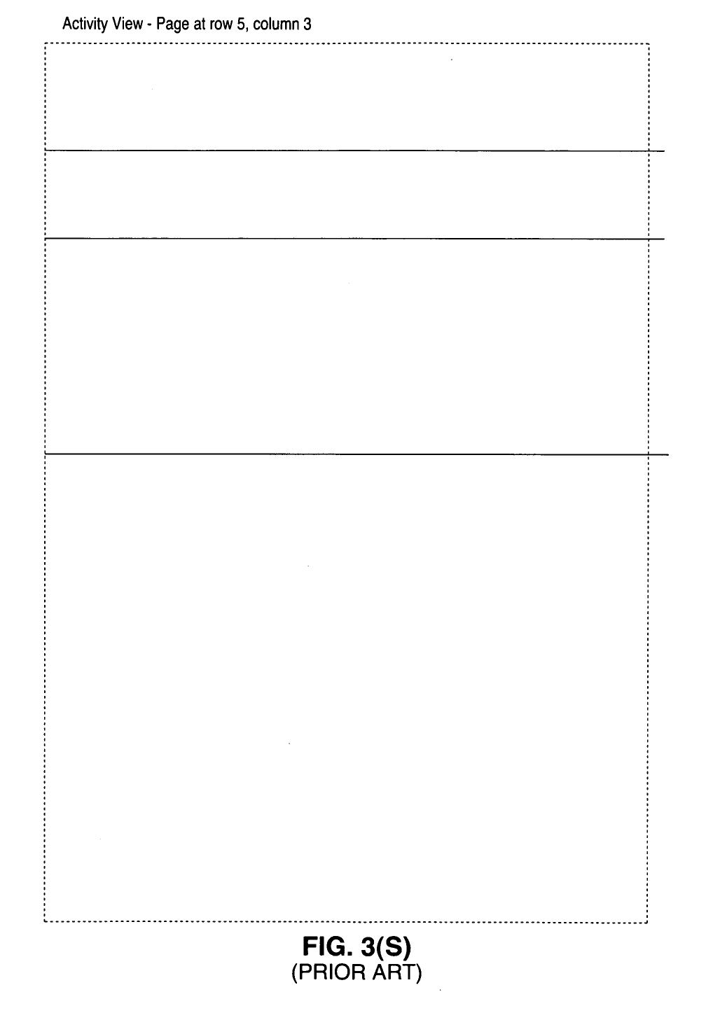

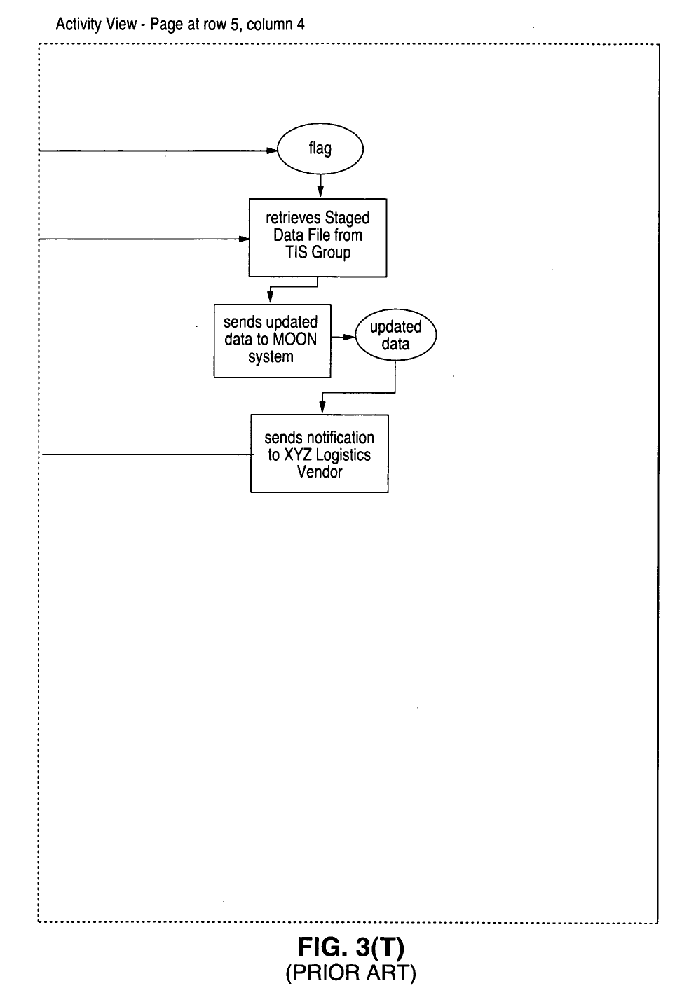

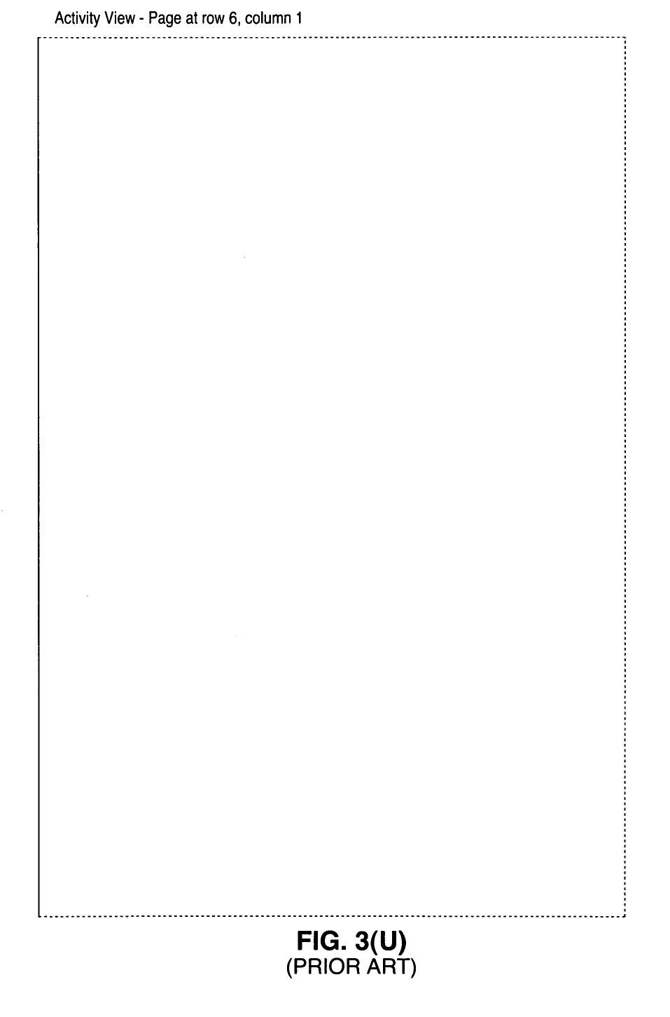

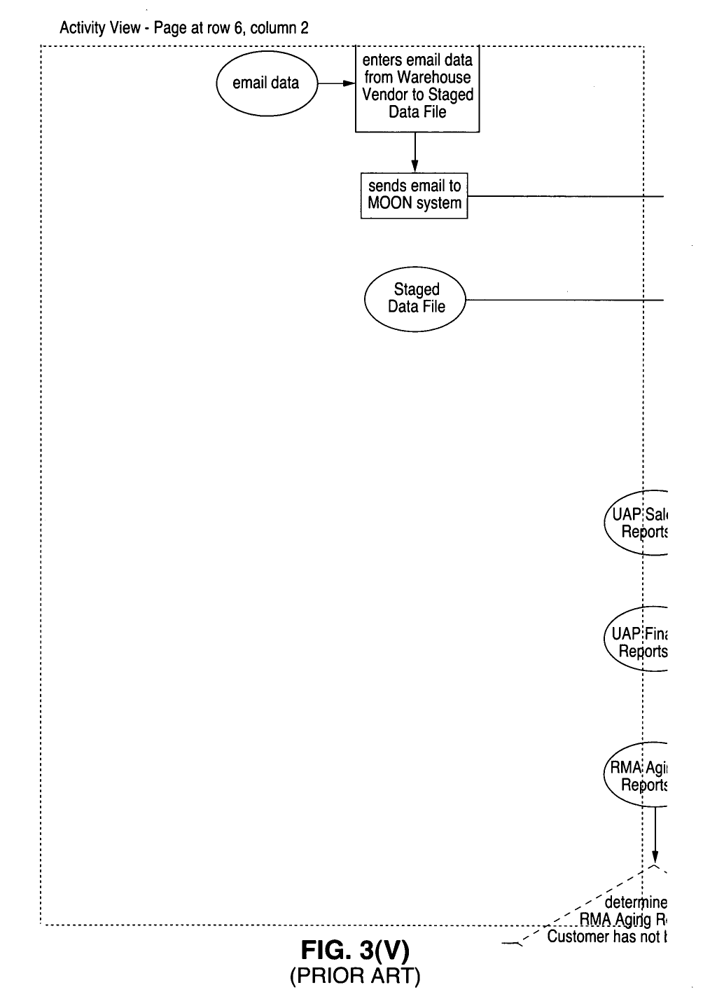

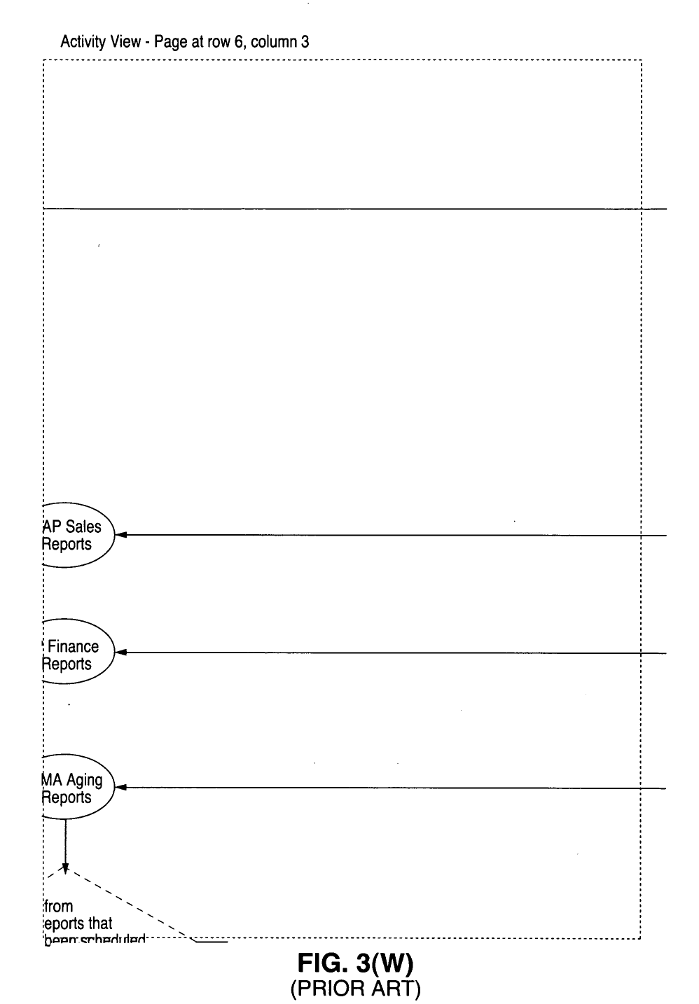

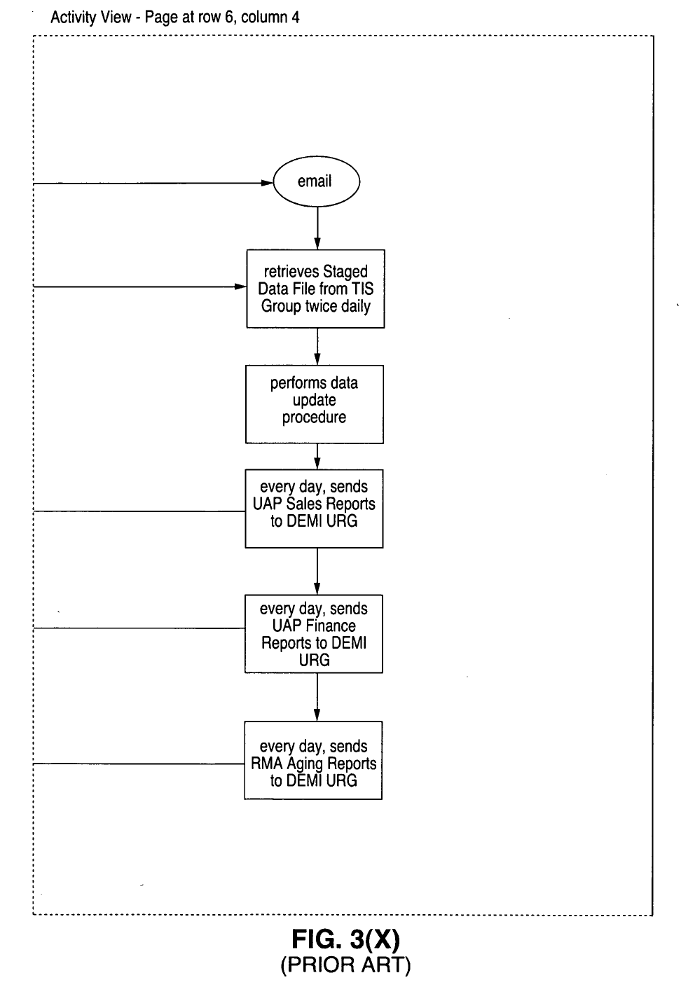

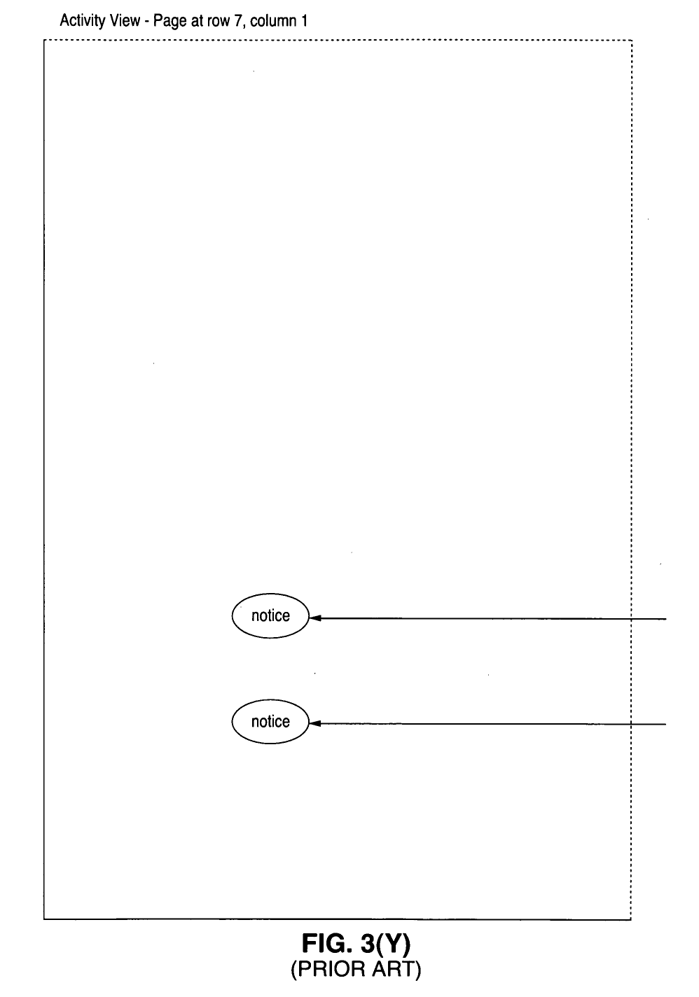

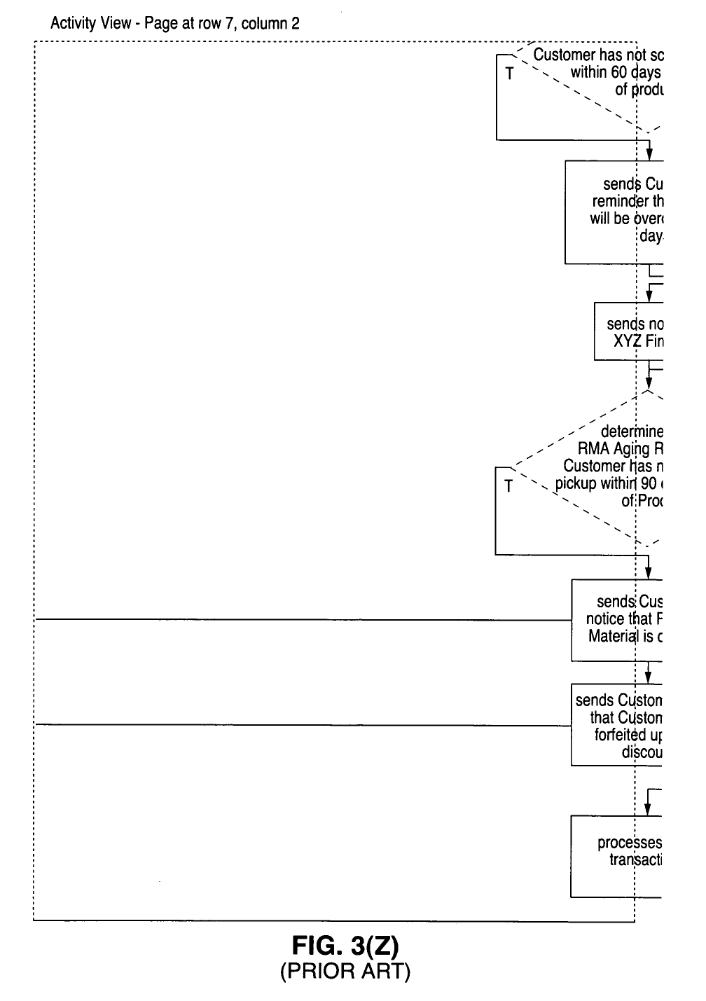

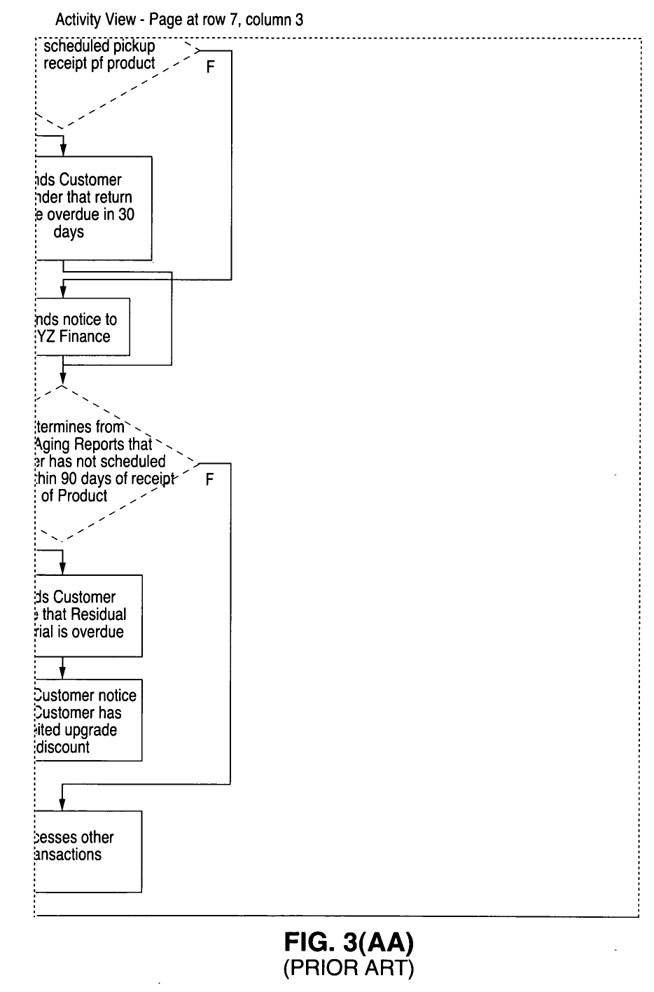

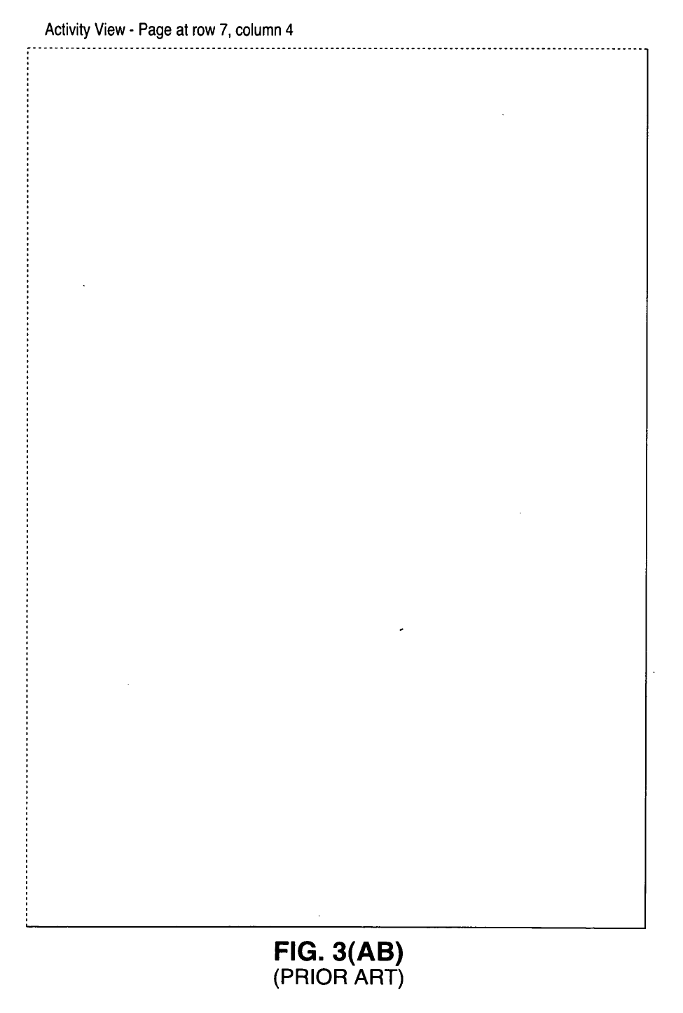

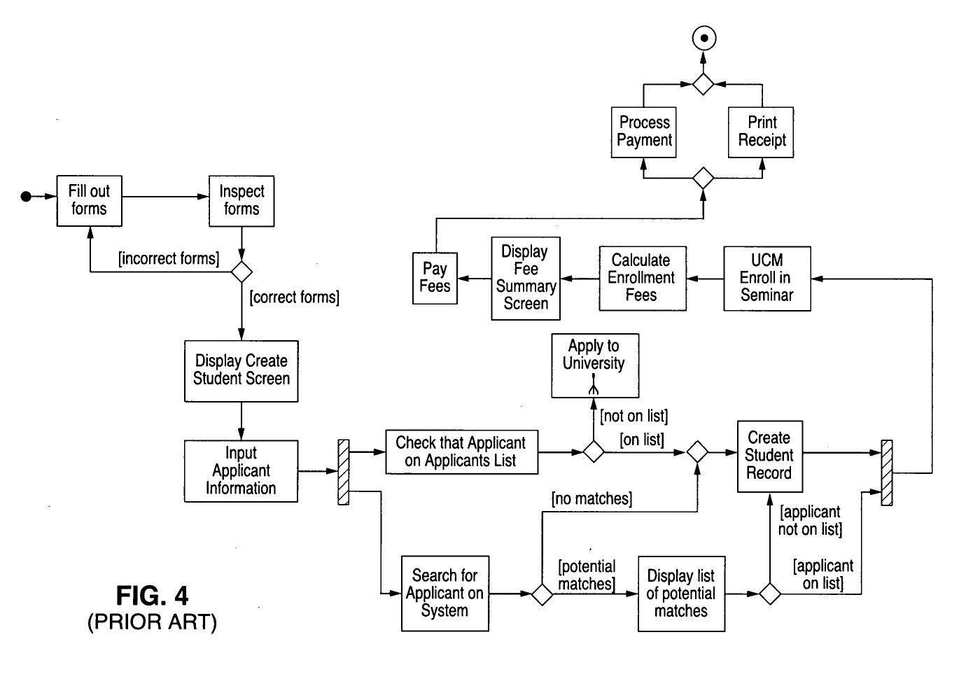

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

As described above, there is a need to represent Activity Diagrams in a manner that is both legible and navigable. Accordingly, the present invention is a system and method for representing such diagrams in a set of individual panels in which the unused swim lanes are eliminated in each panel and in which the navigation is purely vertical. At a minimum, the present invention helps clarify process flow and provides a legible and navigable visual reference for understanding textual descriptions of systems, software, and other processes. The present invention extends upon the production of an object model representing text to a method and system for partitioning and representing Activity Diagrams that makes large diagrams both legible and navigable.

According to one embodiment of the present invention, an Activity Diagram is partitioned into appropriately-sized panels. The panels are arranged in the time order of the activities in them. Unused swim lanes are eliminated from each panel, and thus each panel is compressed without adversely affecting legibility. Each swim lane is labeled on each panel (such that each “column” may represent a different swim lane from panel to panel). Conditional elements are repeated (and flagged when repeated) if necessary to represent their second path on one or more later panels in the sequence. The panels are displayed to a reader in any of a number of possible media (e.g., electronic, printed, etc.).

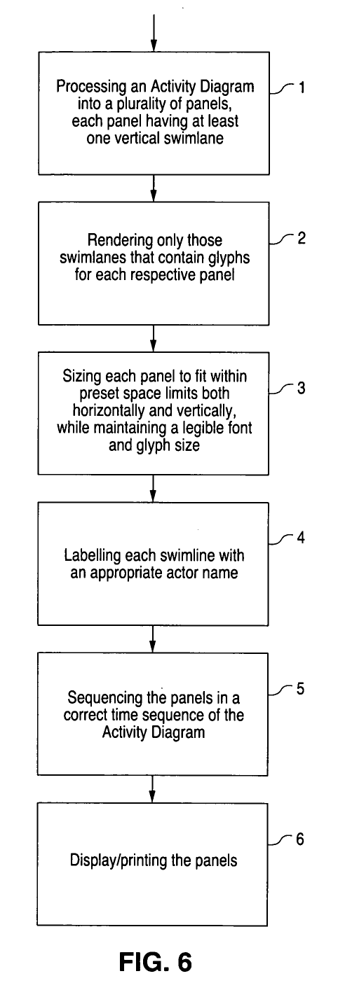

As shown in FIG. 6, a method of partitioning an Activity Diagram according to the present invention may be implemented by performing the illustrated steps. First, an Activity Diagram is processed into a plurality of panels, each panel having at least one vertical swim lane (step 1). Next, only those swim lanes that contain glyphs for each respective panel are actually rendered by the system (step 2). Each panel is sized to fit within preset space limits both horizontally and vertically, while maintaining a legible font and glyph size (step 3). Each vertical swim lane within each panel is labeled with an appropriate actor name (step 4). The panels are then sequenced in a correct time sequence of the Activity Diagram (step 5). Finally, the panels can be displayed and/or printed as desired (step 6). In addition, the panels could be exported to another program, instead of printed.

Note that this exact order of operation by the software is not necessarily required, as long as the output is generated accordingly. Each step of this flowchart may be implemented in a computer system as a software module for execution by a processor. The software may comprise a single unit or may comprise various interrelated modules and sub-modules.

As noted above, for conditional elements, if two paths out of a conditional element cannot be represented within a single panel, then the conditional element is repeated in a subsequent panel to show an additional path, and the repeated conditional element is flagged to show that the conditional element has been repeated. This provides a viewer the necessary context for each panel.

In addition, the system may further comprise an export module to export a generated set of panels electronically other programs.

Thus, the present invention represents Activity Diagrams in usable and publishable form. In a preferred embodiment, a system such as RAVEN™ takes text input and produces a graphical representation. An object model is created from the text and then that object model is diagrammed in a form such as the standard Object-Oriented (“Universal Modeling Language”) diagram called the Activity Diagram. In one embodiment, the present invention is part of the process wherein business analysts use this visual-diagram-producing capability to give them feedback on how to fine-tune their textual descriptions of use cases into the very precise language that benefits system implementers. One result is that business analysts can more effectively bridge the gap between requirements definition and object-oriented software implementation of systems.

In one embodiment, an important aspect of the present invention is that the diagrams must be easily readable. The diagrams provide a visual feedback mechanism to the user to show where and how the text should be made more precise and more complete. The present invention, including the presentation of data described herein, is designed to work together to elicit precision out of the user (i.e., getting correct textual descriptions of use cases). This means that the text is very much in line with the precision required by implementers rather than being the typical vague or ambiguous text that even experienced business analysts normally produce when preparing requirements or process descriptions. Thus the diagrams are a result, but also the improved descriptions that follow from feedback the user receives from the diagrams while the text description is entered and/or modified.

As noted above, one implementation of the present invention is based on using the underlying object model produced by RAVEN™ from plain English text. Because that object model is an algebraic representation of the text, the present invention is able to easily leverage that to produce a set of panels that are appropriately partitioned and labeled. However, the invention is not dependent on an underlying object model and can be utilized even in hand-drawn diagrams or in diagrams produced using drag-and-drop tools such as Microsoft Visio™.

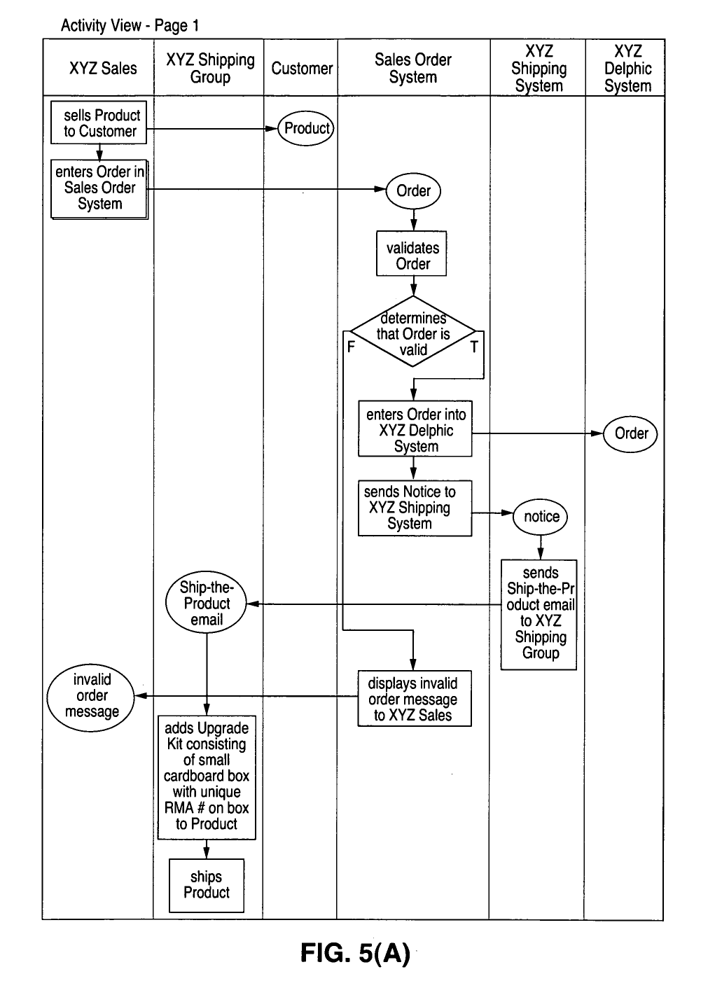

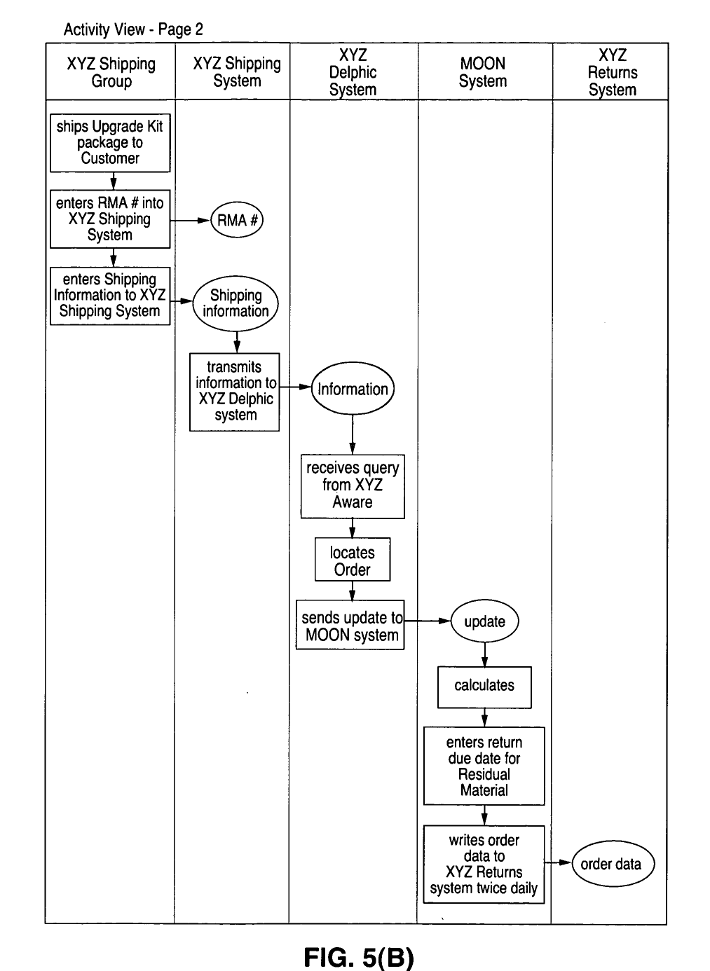

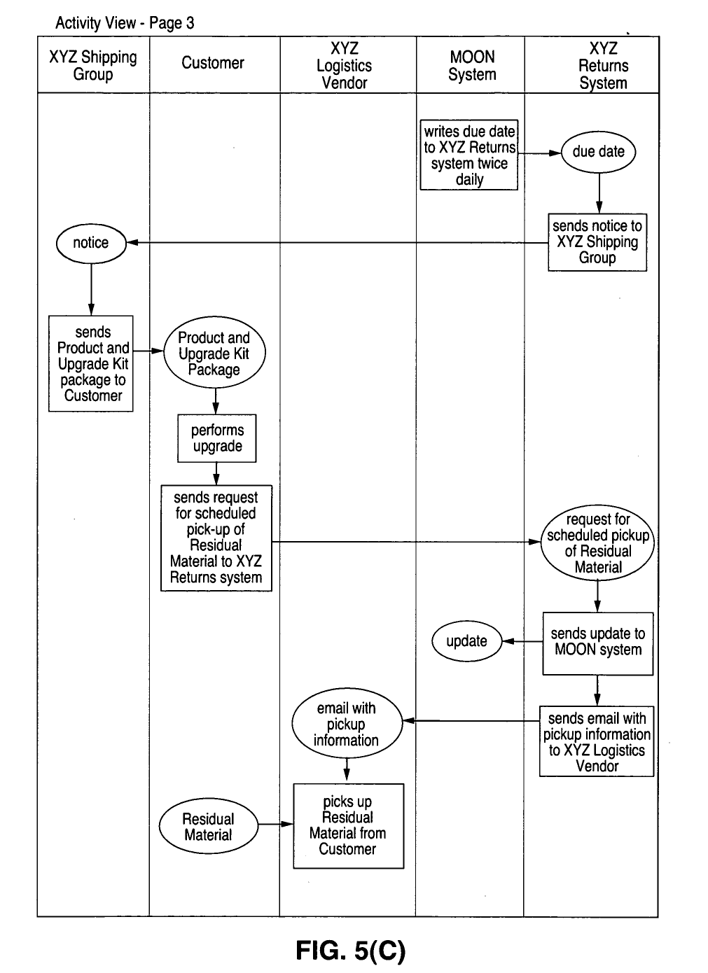

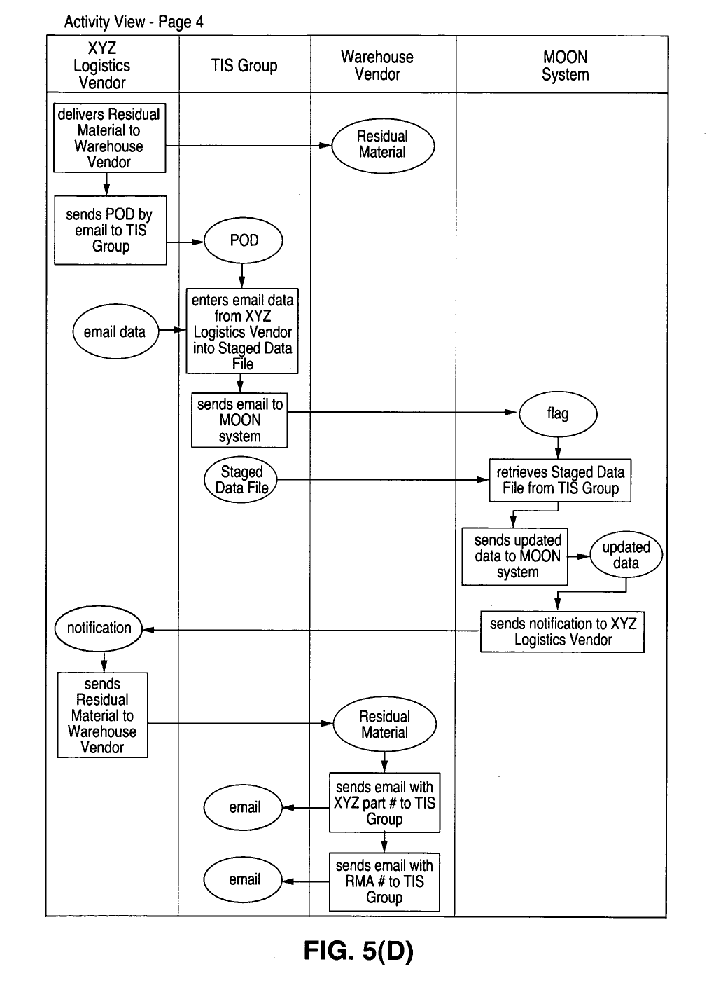

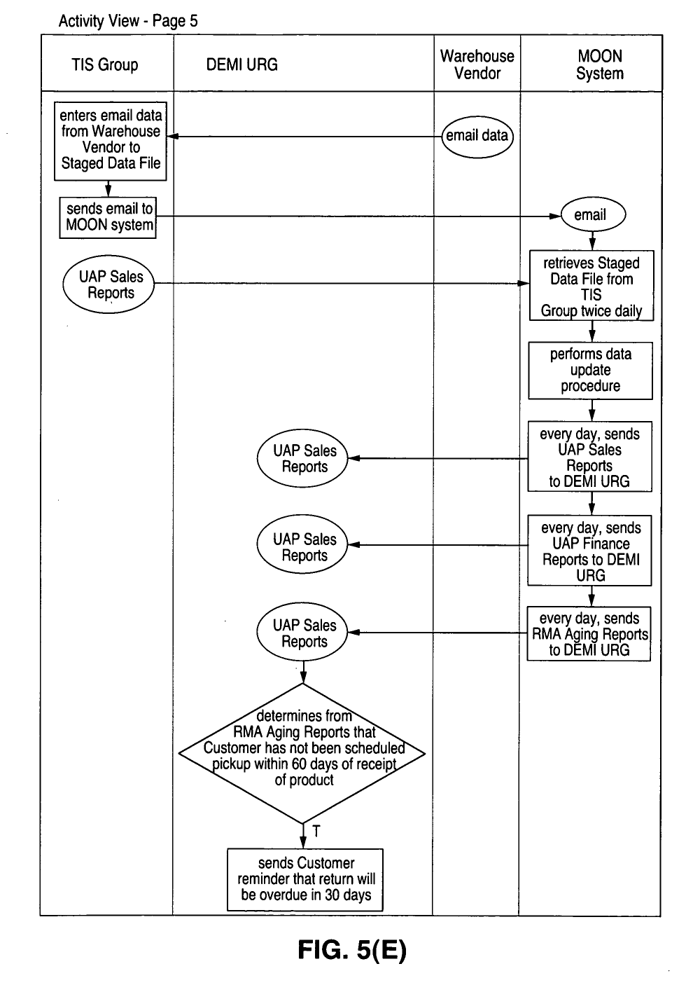

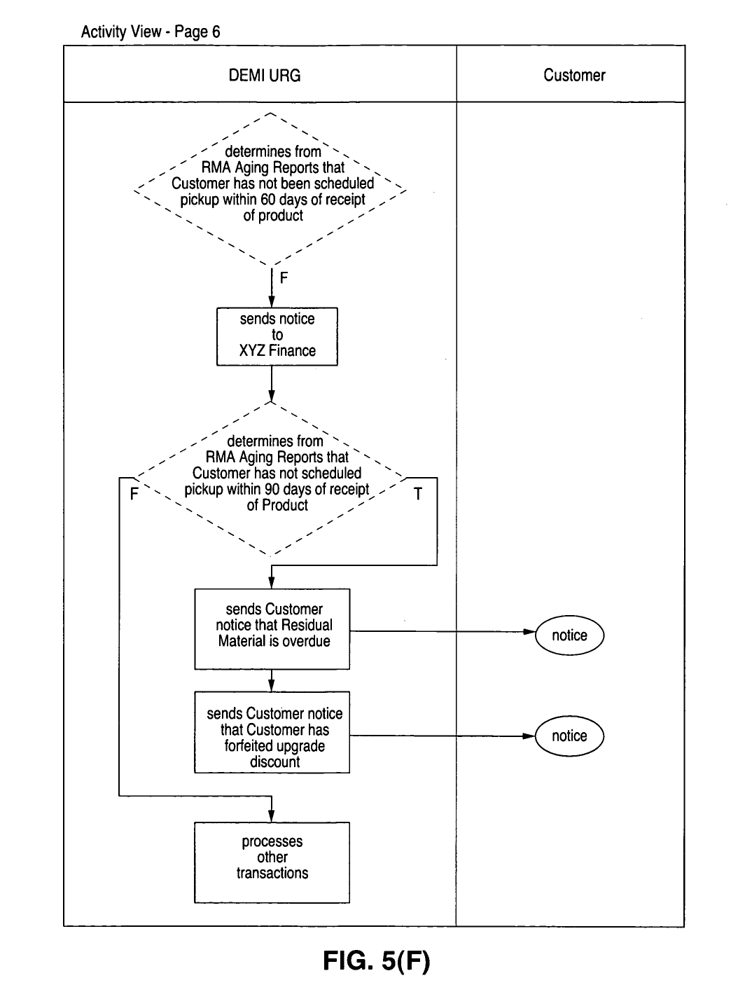

FIGS. 5(A)-5(F) illustrate an output of the invention with just six panels instead of 28, and have a purely vertical navigation from panel to panel. The reader simply traces the flow from the last actor's action (or object) to the same actor's next action at the top of the next panel. This particular implementation automatically adjusts the scope of the panel to maintain legibility, to restrict the number of swim lanes to prevent any horizontal spillover, and to accommodate conditional paths that extend beyond the next panel. In that last situation, the conditional diamond is repeated but with a dashed line outline to indicate a continuation.

The present invention is based on the idea of eliminating unused swim lanes in each panel or section of the diagram. It takes advantage of a reader's ability to follow the flow from panel to panel using the swim lane labels (i.e., actor names) rather than a purely vertical alignment of columns from panel to panel. Note that in panels of FIG. 5, the unused swim lanes have been removed, thereby reducing the total number of panels, while increasing the readability and navigability of the diagram.

The preferred embodiment rests on a core set of processing capabilities to translate the natural language (e.g. text) input to a formalized language, the object model that is machine interpretable. Preferably, the object model is constructed using the techniques and processes described in Manson, U.S. Pat. No. 7,085,708 the contents of which are incorporated herein by reference in its entirety. Although currently preferred, the present invention is not limited to the object model produced using Manson. Other methods of producing an object model may be utilized, or, if desired, no object model need be used.

Portions of the present invention are intended to be implemented using a conventional general purpose or a specialized digital computer or microprocessor programmed according to the teachings of the present disclosure, as will be apparent upon review of the disclosure to those skilled in the computer art.

Appropriate software coding can be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CDRW±, micro-drive, and magneto-optical disks, ROMs, RAMs, EPROMs, EEPROMs, DRAMs, VRAMs, flash memory devices (including flash cards, memory sticks), magnetic or optical cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, displaying Activity Diagrams, partitioning the diagrams into appropriately sized panels according to the pattern taught by the invention, exporting those partitioned diagrams to a display program or to a word processing program such as Microsoft Word™ for insertion into an electronic document, and windows rendering and the display, storage, or communication of results according to the processes of the present invention.

The present invention may suitably comprise, consist of, or consist essentially of, any element (the various parts or features of the invention and their equivalents as described herein). Further, the present invention illustratively disclosed herein may be practiced in the absence of any element, whether or not specifically disclosed herein. Obviously, numerous modifications and variations of the present invention are possible in light of the above teachings.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed is:

1. A method for partitioning an Activity Diagram comprising:
processing an Activity Diagram into a plurality of panels, each panel having at least one vertical swim lane;
rendering only those swim lanes that contain glyphs for each respective panel;
sizing each panel to fit within preset space limits both horizontally and vertically, while maintaining a legible font and glyph size;
labeling each swim lane with an appropriate actor name;
sequencing the panels in a correct time sequence of the Activity Diagram; and
displaying the panels.

2. The method according to claim 1, wherein if two paths out of a conditional element cannot be represented within a single panel, then the conditional element is repeated in a subsequent panel to show an additional path, and wherein the repeated conditional element is flagged to show that the conditional element has been repeated.

3. The method according to claim 1, wherein the step of displaying comprises printing the partitioned Activity Diagram.

4. The method according to claim 1, wherein the step of displaying comprises rendering the Activity Diagram in an application format.

5. The method according to claim 1, wherein the step of displaying comprises inserting the panels into an electronic document.

6. The method according to claim 1, wherein the step of displaying comprises inserting the panels into a Microsoft Visio™ document.

7. The method according to claim 1, wherein the steps of processing, rendering, sizing, labeling, sequencing, and displaying are automatically performed without user intervention.

8. The method according to claim 1, wherein the method is embodied in a set of computer instructions stored on a computer readable media, such that when loaded into a computer, the instructions cause the computer to perform the steps of the method.

9. The method according to claim 8, wherein said computer instruction are compiled computer instructions stored as an executable program on said computer readable media.

10. The method according to claim 1, further comprising printing each panel.

11. A system comprising:
a diagram rendering module that converts an Activity Diagram or an Activity Diagram's underlying object model into a readable and navigable set of panels, wherein each panel has at least one vertical swim lane; the rendering module rendering only those swim lanes that contain glyphs for each respective panel.

12. The system of claim 11, further comprising a sizing module to size each panel to fit within preset space limits both horizontally and vertically, while maintaining a legible font and glyph size.

13. The system of claim 12 further comprising a labeling module to label each swim lane with an appropriate actor name.

14. The system of claim 13 further comprising a sequencing module to sequence the panels in a correct time sequence of the Activity Diagram.

15. The system of claim 14, further comprising a display module to display the set of panels electronically.

16. The system of claim 14, further comprising an export module to export the set of panels electronically to other software programs.

18. The system of claim 15, further comprising a print module that prints the set of panels on a printer or plotter.
